(19) United States
(12) Patent Application Publication
(10) Pub. No.: US 2025/0239395 A1
(43) Pub. Date: Jul. 24, 2025

(54) MULTILAYER COIL COMPONENT

(71) Applicant: TDK CORPORATION, Tokyo (JP)

(72) Inventors: Yusuke NAGAI, Tokyo (JP); Makoto Yoshino, Tokyo (JP); Hidenobu Umeda, Tokyo (JP); Shinichi Sato, Tokyo (JP); Yuya Ishima, Tokyo (JP); Kosuke Ito, Tokyo (JP); Youhei Iida, Tokyo (JP); Mitsuharu Koike, Tokyo (JP); Keito Yasuda, Tokyo (JP)

(73) Assignee: TDK CORPORATION, Tokyo (JP)

(21) Appl. No.: 19/009,140

(22) Filed: Jan. 3, 2025

(30) Foreign Application Priority Data
Jan. 24, 2024 (JP) 2024-008709

(51) Int. Cl. H01F 27/29; H01F 5/00

(52) U.S. Cl. CPC H01F 27/292; H01F 5/003

(57) ABSTRACT

A multilayer coil component includes an element body, a coil disposed in the element body, and an external electrode exposed on the element body. The external electrode is electrically connected to the coil. The element body includes a stress reduction layer positioned between the coil and the external electrode.

### CROSS-REFERENCE TO RELATED APPLICATIONS

This application is based upon and claims the benefit of priority from Japanese Patent Application No. 2024-008709, filed On Jan. 24, 2024, the entire contents of which are incorporated herein by reference.

### BACKGROUND

### Field

The present disclosure relates to a multilayer coil component.

### Description of the Related Art

A multilayer coil component including an element body, a coil disposed in the element body, and an external electrode electrically connected to the coil and exposed on the element body has been known (for example, Japanese Unexamined Patent Publication No. 2011-009391). A surface of the external electrode includes a mounting surface and is opposed to an electronic device on which the multilayer coil component is mounted.

### SUMMARY

An object of one aspect of the present disclosure is to provide a multilayer coil component that reduces stress acting on a mounting surface.

A multilayer coil component according to one aspect of the present disclosure includes an element body, a coil disposed in the element body, and an external electrode exposed on the element body. The external electrode is electrically connected to the coil. The element body includes a stress reduction layer positioned between the coil and the external electrode.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a multilayer coil component according to a first embodiment;

FIG. 2 is a perspective view illustrating a coil according to the first embodiment.

FIG. 3 is an exploded view illustrating a configuration of the multilayer coil component according to the first embodiment;

FIG. 4 is a diagram illustrating a configuration of a section of the multilayer coil component according to the first embodiment;

FIG. 5 is a diagram illustrating a configuration of a section of a multilayer coil component according to a second embodiment;

FIG. 6 is a diagram illustrating a configuration of a section of a multilayer coil component according to a third embodiment; and

FIG. 7 is a diagram illustrating a configuration of a section of a multilayer coil component according to a fourth embodiment.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

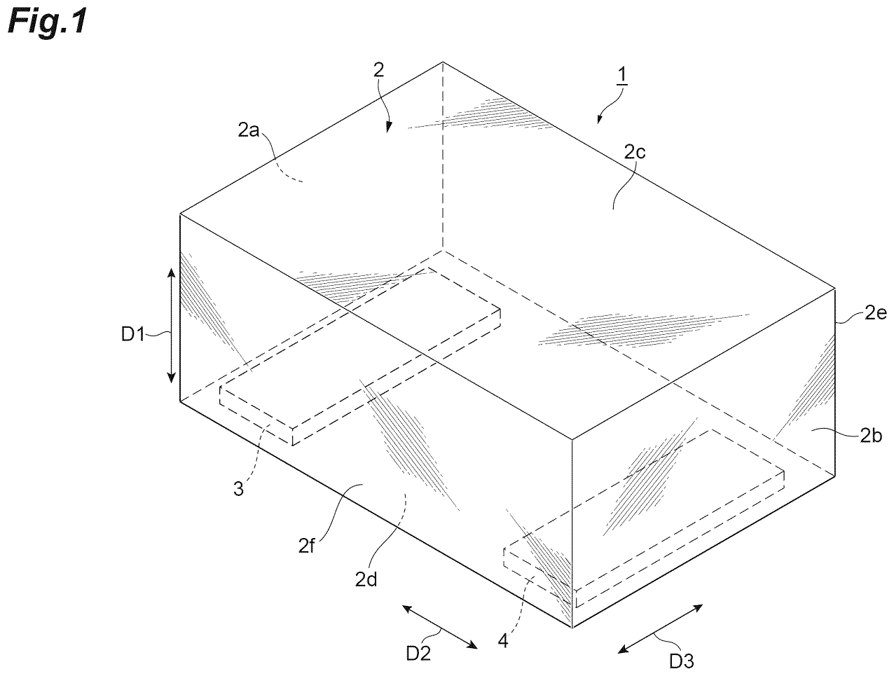

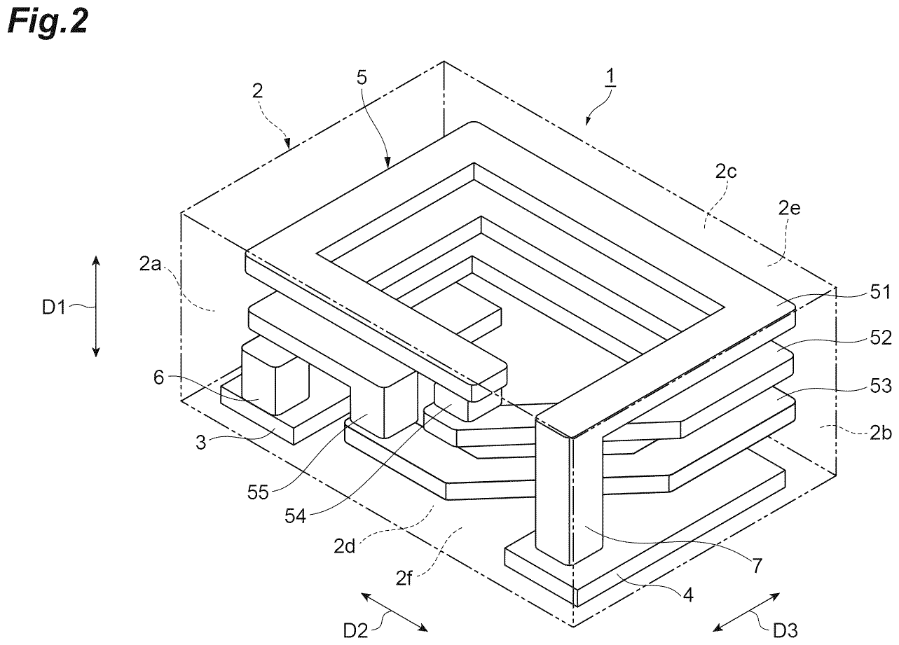

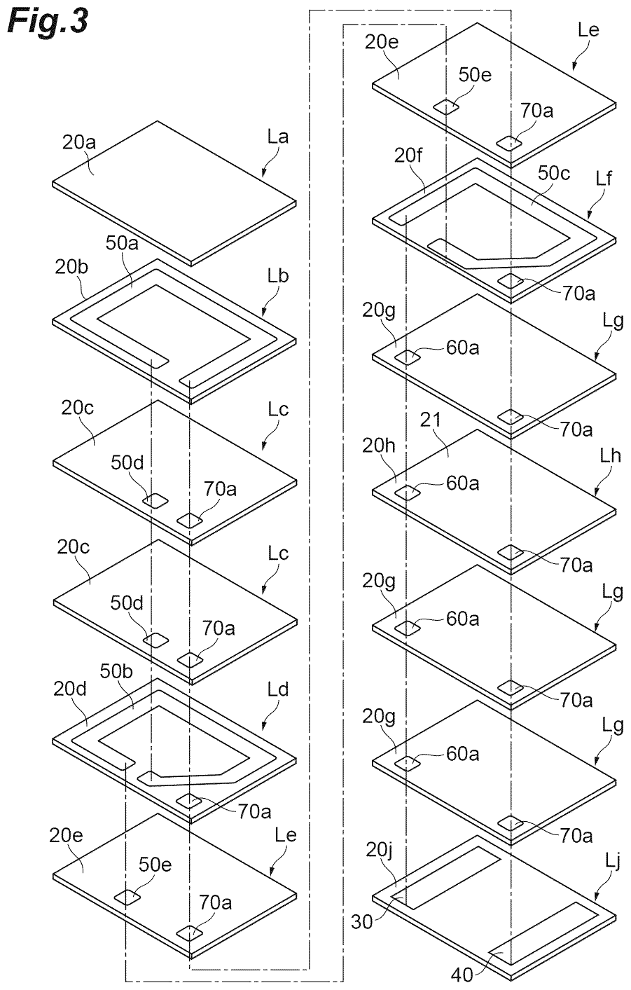

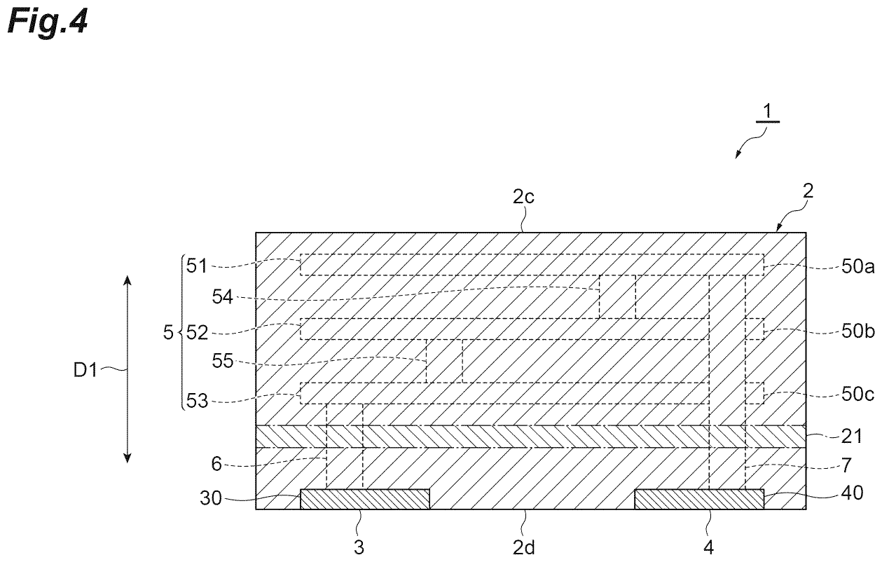

A multilayer coil component 1 according to a first embodiment will be described with reference to FIGS. 1 to 4. FIG. 1 is a perspective view of the multilayer coil component according to the first embodiment. FIG. 2 is a perspective view illustrating a coil according to the first embodiment. FIG. 3 is an exploded view illustrating a configuration of the multilayer coil component according to the first embodiment. FIG. 4 is a diagram illustrating a configuration of a section of the multilayer coil component according to the first embodiment. As illustrated in FIGS. 1 and 2, the multilayer coil component 1 includes an element body 2, an external electrode 3 and an external electrode 4, a coil 5, and a connection conductor 6 and a connection conductor 7.

The element body 2 has a rectangular parallelepiped shape. The rectangular parallelepiped shape includes a rectangular parallelepiped shape in which corner parts and ridge line parts are chamfered, or a rectangular parallelepiped shape in which corner parts and ridge line parts are rounded. The element body 2 has, as outer surfaces, a pair of end surfaces 2a and 2b, a pair of main surfaces 2c and 2d, and a pair of side surfaces 2e and 2f. The end surfaces 2a and 2b are opposed to each other. The main surfaces 2c and 2d are opposed to each other. The side surfaces 2e and 2f are opposed to each other. In the following description, a direction in which the main surfaces 2c and 2d are opposed to each other is referred to as a direction D1, a direction in which the end surfaces 2a and 2b are opposed to each other is referred to as a direction D2, and a direction in which the side surfaces 2e and 2f are opposed to each other is referred to as a direction D3. The direction D1, the direction D2, and the direction D3 are substantially orthogonal to each other.

The end surfaces 2a and 2b extend in the direction D1 to link the main surfaces 2c and 2d. The end surfaces 2a and 2b also extend in the direction D3 to link the side surfaces 2e and 2f. The main surfaces 2c and 2d extend in the direction D2 to link the end surfaces 2a and 2b. The main surfaces 2c and 2d also extend in the direction D3 to link the side surfaces 2e and 2f. The side surfaces 2e and 2f extend in the direction D1 to connect the main surfaces 2c and 2d. The side surfaces 2e and 2f also extend in the direction D2 to connect the end surfaces 2a and 2b.

The main surface 2d is included in a mounting surface, and is a surface opposed to another electronic device (not illustrated), for example, when the multilayer coil component 1 is mounted on the other electronic device. The other electronic device is, for example, a circuit substrate or a multilayer electronic component. The end surfaces 2a and 2b and the side surfaces 2e and 2f are surfaces continuous from the mounting surface. The mounting surface is, that is, the main surface 2d.

A length of the element body 2 in the direction D2 is longer than a length of the element body 2 in the direction D1 and a length of the element body 2 in the direction D3. The length of the element body 2 in the direction D3 is longer than the length of the element body 2 in the direction D1. In other words, in the present embodiment, the end surfaces 2a and 2b, the main surfaces 2c and 2d, and the side surfaces 2e and 2f each have an oblong shape. The length of the element body 2 in the direction D1 may be equivalent to the length of the element body 2 in the direction D3, or many be shorter than the length thereof.

It should be noted that “equivalent” in the present embodiment may not only mean equal but also mean equivalent to a value including a slight difference, a manufacturing error, or the like in a preset range. For example, when a plurality of values are included within a range of ±20% of an average value of the plurality of values, the plurality of values are defined to be equivalent.

The element body 2 includes a metal component and a resin component. The metal component includes, for example, a plurality of metal particles. In one example, the metal particles include a soft magnetic alloy. The soft magnetic alloy is, for example, a Fe—Si-based alloy. The soft magnetic alloy may be, for example, a Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements. In the element body 2, the metal particles are bonded to each other. The bonding between the metal particles is realized by, for example, bonding between oxide films formed on surfaces of the metal particles. An average particle diameter of the metal particles is 0.5 μm or more and 15 μm or less. In the present embodiment, the average particle diameter of the metal particles is 5 μm. The “average particle diameter” is calculated, for example, from at least one section of the element body 2. In one example, the particle diameter means a particle diameter at an integrated value of 50% in a particle size distribution obtained by performing image processing on an image of at least one section of the element body 2.

The resin component is made of, for example, a resin interposed between a plurality of metal magnetic particles. The resin may be impregnated into voids present between the plurality of adjacent metal magnetic particles. In one example, the resin is made of an insulating resin having electrical insulation properties. The resin may include, for example, a silicone resin, a phenol resin, an acrylic resin, or an epoxy resin.

The external electrodes 3 and 4 are electrically connected to the coil 5. The external electrodes 3 and 4 are exposed on the element body 2. The external electrodes 3 and 4 are exposed in the same orientation as the main surface 2d. The external electrodes 3 and 4 are disposed to be exposed only in the same orientation as the main surface 2d of the surfaces of the element body 2. The mounting surface of the element body 2 includes surfaces of the external electrodes 3 and 4 and the main surface 2d. The external electrode 3 and the external electrode 4 are arranged away from each other in the direction D2. The external electrode 3 is positioned near the end surface 2a of the element body 2. The external electrode 4 is positioned near the end surface 2b of the element body 2. As viewed from the direction D1, the external electrodes 3 and 4 are positioned away from ridge lines between the main surface 2d, the end surfaces 2a and 2b, and the side surfaces 2e and 2f. As viewed from the direction D1, the external electrodes 3 and 4 each have a rectangular shape. The external electrodes 3 and 4 each have long sides along the direction D3 and short sides along the direction D2.

The external electrodes 3 and 4 include a conductive material. The conductive material is, for example, Ag or Pd. The external electrodes 3 and 4 are made of a sintered body of a conductive paste. The conductive paste includes conductive metal powder and a glass frit. The conductive metal powder is, for example, Ag powder or Pd powder. A plated layer may be formed on each surface of the external electrodes 3 and 4. The plated layer is formed through, for example, electroplating. The electroplating is, for example, Ni electroplating or Sn electroplating. The external electrodes 3 and 4 may protrude from the main surface 2d.

The coil 5 includes a plurality of coil conductors 51, 52, and 53 and a plurality of through-hole conductors 54 and 55. The plurality of coil conductors 51, 52, and 53 are arranged in this order (coil conductor 51, coil conductor 52, and coil conductor 53) along the direction D1. The coil conductor 51 and the coil conductor 52 are electrically connected to each other via the through-hole conductor 54. The coil conductor 52 and the coil conductor 53 are electrically connected to each other via the through-hole conductor 55. The coil conductor 53 is positioned closest to the main surface 2d and includes a first end of the coil 5 in the direction D1. The coil conductor 51 is disposed closest to the main surface 2c and includes a second end of the coil 5 in the direction D1. Each of the coil conductors 51 to 53 includes a part of a spiral track in the coil 5. The coil 5 includes a conductive material. The conductive material is, for example, Ag, Pd, Cu, Al, or Ni. The plurality of coil conductors 51 to 53 may be plated conductors.

The connection conductor 6 is disposed in the element body 2. The connection conductor 6 connects the external electrode 3 and the coil 5. The connection conductor 6 is a through-hole conductor. The connection conductor 6 extends in the direction D1 and is connected to the external electrode 3 and the first end of the coil 5. The connection conductor 7 is disposed in the element body 2. The connection conductor 7 connects the external electrode 4 and the coil 5. The connection conductor 7 is a through-hole conductor. The connection conductor 7 extends in the direction D1 and is connected to the external electrode 4 and the second end of the coil 5. The connection conductor 6 and the connection conductor 7 have a prismatic shape with the direction D1 as a longitudinal direction.

As illustrated in FIG. 3, the multilayer coil component 1 includes a plurality of layers laminated in an order of a layer La, a layer Lb, a layer Lc, a layer Lc, a layer Ld, a layer Le, a layer Le, a layer Lf, a layer Lg, a layer Lh, a layer Lg, a layer Lg, and a layer Lj. The layer La includes the main surface 2c, and the layer Lj includes the main surface 2d. Thicknesses of the layers La to Lj are equivalent. In one example, the thickness of each of the layers La to Lj is 1 μm or more and 500 μm or less. In the multilayer coil component 1, a direction defining the thickness is along the direction D1.

In the multilayer coil component 1, the element body 2 includes a plurality of layers laminated in an order of a layer 20a, a layer 20b, a layer 20c, a layer 20c, a layer 20d, a layer 20e, a layer 20e, a layer 20f, a layer 20g, a layer 20h, a layer 20g, a layer 20g, and a layer 20j. The layer 20h includes a stress reduction layer 21. The layers 20a to 20j are integrated to such an extent that boundaries between the layers cannot be visually recognized.

The coil 5 includes a plurality of coil conductor layers laminated in an order of a coil conductor layer 50a, a plurality of through-hole conductor layers 50d, a coil conductor layer 50b, a plurality of through-hole conductor layers 50e, and a coil conductor layer 50c. In the multilayer coil component 1, the number of each of the through-hole conductor layers 50d and 50e is “2”. The coil conductor layer 50a includes the coil conductor 51, the coil conductor layer 50b includes the coil conductor 52, and the coil conductor layer 50c includes the coil conductor 53. The plurality of through-hole conductor layers 50d include the through-hole conductor 54, and the plurality of through-hole conductor layers 50e include the through-hole conductor 55. The coil conductor layers 50a to 50c and the through-hole conductor layers 50d and 50e are integrated to such an extent that boundaries between the layers cannot be visually recognized.

The connection conductor 6 includes a plurality of laminated connection conductor layers 60a. In the multilayer coil component 1, the number of the plurality of connection conductor layers 60a is “4”. The plurality of connection conductor layers 60a are integrated to such an extent that boundaries between the layers cannot be visually recognized. The connection conductor 7 includes a plurality of laminated connection conductor layers 70a. In the multilayer coil component 1, the number of the plurality of connection conductor layers 70a is “10”. The plurality of connection conductor layers 70a are integrated to such an extent that boundaries between the layers cannot be visually recognized. The external electrode 3 includes an external electrode layer 30. The external electrode 4 includes an external electrode layer 40.

The layer La includes the layer 20a. The layer 20a includes the main surface 2c.

The layer Lb includes the layer 20b and the coil conductor layer 50a. The coil conductor layer 50a is provided in a defect portion formed in the layer 20b.

The layer Lc includes the layer 20c, the through-hole conductor layer 50d, and the connection conductor layer 70a. The through-hole conductor layer 50d and the connection conductor layer 70a are provided in a defect portion formed in the layer 20c.

The layer Ld includes the layer 20d, the coil conductor layer 50b, and the connection conductor layer 70a. The coil conductor layer 50b and the connection conductor layer 70a are provided in a defect portion formed in the layer 20d.

The layer Le includes the layer 20e, the through-hole conductor layer 50e, and the connection conductor layer 70a. The through-hole conductor layer 50e and the connection conductor layer 70a are provided in a defect portion formed in the layer 20e.

The layer Lf includes the layer 20f, the coil conductor layer 50c, and the connection conductor layer 70a. The coil conductor layer 50c and the connection conductor layer 70a are provided in a defect portion formed in the layer 20f.

The layer Lg includes the layer 20g, the connection conductor layer 60a, and the connection conductor layer 70a. The connection conductor layer 60a and the connection conductor layer 70a are provided in a defect portion formed in the layer 20g.

The layer Lh includes the layer 20h, the connection conductor layer 60a, and the connection conductor layer 70a. The connection conductor layer 60a and the connection conductor layer 70a are provided in a defect portion formed in the layer 20h.

The layer Lj includes the layer 20j and the external electrode layers 30 and 40. The external electrode layers 30 and 40 are provided in a defect portion formed in the layer Lj. The layer 20j includes the main surface 2d.

As illustrated in FIG. 4, the stress reduction layer 21 is positioned between the coil 5, and the external electrodes 3 and 4. A portion other than the stress reduction layer 21 of the element body 2 is interposed between the stress reduction layer 21 and the coil 5 in the direction D1. A portion other than the stress reduction layer 21 of the element body 2 is interposed between the stress reduction layer 21 and the external electrodes 3 and 4 in the direction D1. The stress reduction layer 21 is along the direction D2 and the direction D3 intersecting the direction D1. End surfaces of the stress reduction layer 21 in the direction D2 may be included in the end surfaces 2a and 2b. End surfaces of the stress reduction layer 21 in the direction D3 may be included in the side surfaces 2e and 2f. In one example, a thickness of the stress reduction layer 21 is 1 μm or more and 300 μm or less.

The stress reduction layer 21 and the portion other than the stress reduction layer 21 of the element body 2 each include a metal component and a resin component. A ratio of the resin component to the metal component in the stress reduction layer 21 is larger than a ratio of the resin component to the metal component in the portion other than the stress reduction layer 21 of the element body 2. A volume content of the resin component in the stress reduction layer 21 may be larger than a volume content of the resin component in the portion other than the stress reduction layer 21 of the element body 2. The volume content of the resin component is calculated, for example, from sections of the stress reduction layer 21 and the portion of the element body 2 other than the stress reduction layer 21. In one example, the volume content of the resin component in the stress reduction layer 21 is larger by at least 1% than the volume content of the resin component in the portion other than the stress reduction layer 21 of the element body 2. A mass content of the resin component in the stress reduction layer 21 may be larger than a mass content of the resin component in the portion other than the stress reduction layer 21 of the element body 2. In one example, the mass content of the resin component in the stress reduction layer 21 is larger by at least 1% than the mass content of the resin component in the portion other than the stress reduction layer 21 of the element body 2.

The ratio of the resin component to the metal component of the stress reduction layer 21 may change corresponding to a position of the stress reduction layer 21 between the coil 5, and the external electrodes 3 and 4. The position between the coil 5, and the external electrodes 3 and 4 includes a position in the direction D1. For example, a ratio of the resin component to the metal component in a portion of the stress reduction layer 21 positioned close to the external electrodes 3 and 4 may be larger than a ratio of the resin component to the metal component in a portion of the stress reduction layer 21 positioned close to the coil 5.

A volume content of voids present between the plurality of adjacent metal magnetic particles in the stress reduction layer 21 may be larger than a volume content of voids present between the plurality of adjacent metal magnetic particles in the portion other than the stress reduction layer 21 of the element body 2. The void may be filled with resin. In one example, the volume content of voids present between the plurality of adjacent metal magnetic particles in the stress reduction layer 21 is at least 1% larger than the volume content of voids present between the plurality of adjacent metal magnetic particles in the portion other than the stress reduction layer 21 of the element body 2. A density of the stress reduction layer 21 may be smaller than a density of the portion other than the stress reduction layer 21 of the element body 2. In one example, the density of the stress reduction layer 21 is at least 1% lower than the density of the portion other than the stress reduction layer 21 of the element body 2.

As described above, the external electrodes 3 and 4 exposed on the element body 2 and the other electronic device are connected via solder. An external force applied to the mounted multilayer coil component 1 acts as stress on the mounting surface included by the main surface 2d and the external electrodes 3 and 4. When the stress acting on the mounting surface exceeds shear strength, the multilayer coil component 1 may be peeled off from the other electronic device.

In the multilayer coil component 1, the element body 2 includes the stress reduction layer 21 positioned between the coil 5, and the external electrodes 3 and 4. The external force applied to the multilayer coil component 1 acts on the mounting surface via the stress reduction layer 21. Since the stress reduction layer 21 absorbs a change in stress due to an impact or the like, the change in stress generated in the element body 2 tends not to act on the mounting surface. Accordingly, the multilayer coil component 1 reduces the stress acting on the mounting surface.

The stress reduction layer 21 and the portion other than the stress reduction layer 21 in the element body 2 each include the metal component and the resin component. The ratio of the resin component to the metal component in the stress reduction layer 21 is larger than the ratio of the resin component to the metal component in the portion other than the stress reduction layer 21 of the element body 2.

The resin component more easily absorbs the change in stress than the metal component. As a result, the multilayer coil component 1 further reduces the stress acting on the mounting surface.

The ratio of the resin component to the metal component of the stress reduction layer 21 may change corresponding to the position of the stress reduction layer 21 between the coil 5, and the external electrodes 3 and 4.

Vibration applied to the mounted multilayer coil component 1 acts as stress on the element body 2. The vibration applied to the multilayer coil component 1 acts on the mounting surface via the stress reduction layer 21. In the configuration in which the ratio of the resin component to the metal component of the stress reduction layer 21 changes corresponding to the position of the stress reduction layer 21 between the coil 5, and the external electrodes 3 and 4, a frequency of the vibration absorbed by the stress reduction layer 21 changes corresponding to the ratio of the resin component to the metal component. As a result, in the configuration in which the ratio of the resin component to the metal component of the stress reduction layer 21 changes corresponding to the position of the stress reduction layer 21 between the coil 5, and the external electrodes 3 and 4, a range of the frequency of the vibration absorbed by the stress reduction layer 21 is wide as compared with a configuration in which the ratio of the resin component to the metal component of the stress reduction layer 21 is constant.

The ratio of the resin component to the metal component in the portion of the stress reduction layer 21 positioned close to the external electrodes 3 and 4 may be larger than the ratio of the resin component to the metal component in the portion of the stress reduction layer 21 positioned close to the coil 5.

Since a portion including more resin components of the stress reduction layer 21 is positioned close to the mounting surface, the stress acting on the mounting surface can be further reduced.

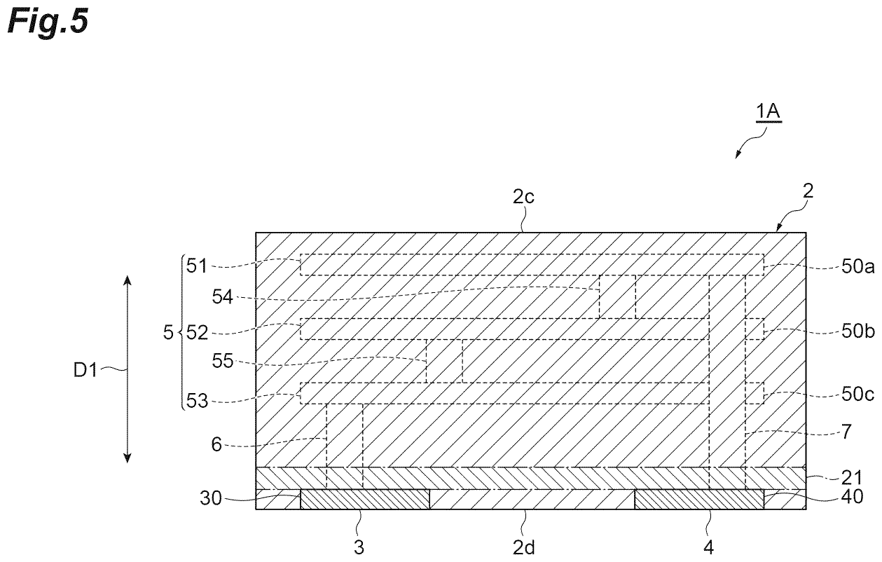

Hereinafter, a multilayer coil component 1A according to a second embodiment will be described with reference to FIG. 5. FIG. 5 is a diagram illustrating a configuration of a section of the multilayer coil component according to the second embodiment. Hereinafter, differences between the multilayer coil component 1 according to the first embodiment and the multilayer coil component 1A according to the second embodiment will be mainly described.

In the multilayer coil component 1A, the stress reduction layer 21 overlaps the external electrodes 3 and 4. In the element body 2, the stress reduction layer 21 is positioned on the external electrodes 3 and 4. The portion other than the stress reduction layer 21 of the element body 2 is not interposed between the stress reduction layer 21 and the external electrodes 3 and 4 in the direction D1. In the direction D1, the stress reduction layer 21 and the external electrodes 3 and 4 are adjacent to each other.

Deflection of the other electronic device on which the multilayer coil component 1A is mounted acts as a bending moment on the multilayer coil component 1A. In a case where the bending moment acts on the multilayer coil component 1A, a difference between a bending deformation of the element body 2 and a bending deformation of the external electrodes 3 and 4 may cause cracks between the element body 2 and the external electrodes 3 and 4.

In the multilayer coil component 1A, since the stress reduction layer 21 overlaps the external electrodes 3 and 4, the element body 2 easily follows the bending deformation of the external electrodes 3 and 4 as compared with a configuration in which the portion other than the stress reduction layer 21 of the element body 2 overlaps the external electrodes 3 and 4. Accordingly, the multilayer coil component 1A is resistant to deflection of the other electronic device on which the multilayer coil component 1A is mounted.

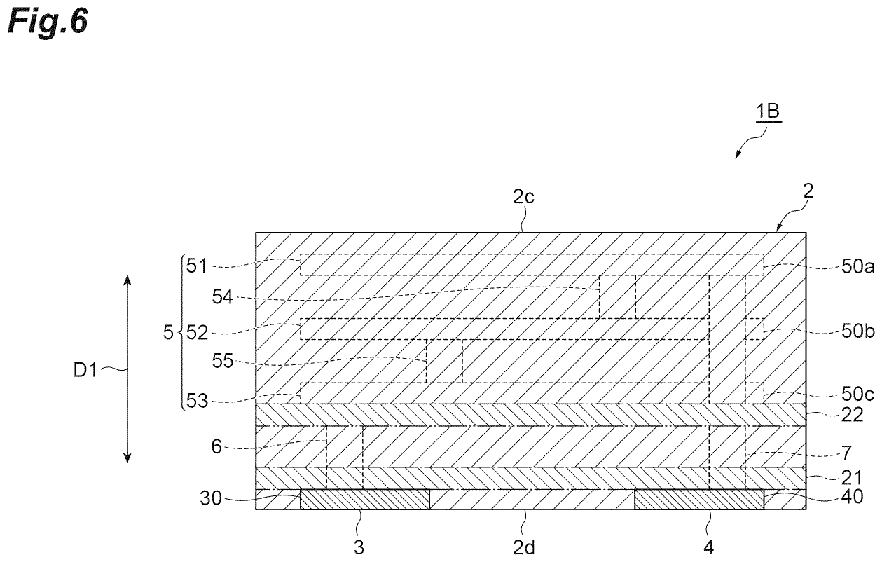

Hereinafter, a multilayer coil component 1B according to a third embodiment will be described with reference to FIG. 6. FIG. 6 is a diagram illustrating a configuration of a section of the multilayer coil component according to the third embodiment. Hereinafter, differences between the multilayer coil component 1A according to the second embodiment and the multilayer coil component 1B according to the third embodiment will be mainly described.

In the multilayer coil component 1B, the element body 2 further includes a stress reduction layer 22 different from the stress reduction layer 21. The stress reduction layer 21 includes a first stress reduction layer, and the stress reduction layer 22 includes a second stress reduction layer. The stress reduction layer 22 is positioned between the stress reduction layer 21 and the coil 5. The stress reduction layer 22 is along the direction D2 and the direction D3 intersecting the direction D1. End surfaces of the stress reduction layer 22 in the direction D2 may be included in the end surfaces 2a and 2b. End surfaces of the stress reduction layer 22 in the direction D3 may be included in the side surfaces 2e and 2f.

The stress reduction layer 22 is disposed to overlap the coil conductor 53. In the element body 2, the coil conductor 53 is positioned on the stress reduction layer 22. The portion other than the stress reduction layer 21 of the element body 2 is interposed between the stress reduction layer 21 and the stress reduction layer 22 in the direction D1.

The stress reduction layer 22 has a ratio of the resin component to the metal component different from the ratio of the resin component to the metal component of the stress reduction layer 21. The ratio of the resin component to the metal component in the stress reduction layer 22 may be smaller than the ratio of the resin component to the metal component in the stress reduction layer 21.

In the multilayer coil component 1B, the element body 2 includes the stress reduction layer 21 and the stress reduction layer 22 positioned between the stress reduction layer 21 and the coil 5. The change in stress generated in the element body 2 is absorbed by both the stress reduction layer 21 and the stress reduction layer 22. Accordingly, the multilayer coil component 1B further reduces the stress acting on the mounting surface.

The stress reduction layer 22 has the ratio of the resin component to the metal component different from the ratio of the resin component to the metal component of the stress reduction layer 21. In the multilayer coil component 1B, the range of the frequency of the vibration absorbed by the stress reduction layer 21 and the stress reduction layer 22 is wide as compared with the configuration in which the ratio of the resin component to the metal component of the stress reduction layer 21 is the same as the ratio of the resin component to the metal component of the stress reduction layer 22.

The ratio of the resin component to the metal component of the stress reduction layer 21 may be larger than the ratio of the resin component to the metal component of the stress reduction layer 22.

Since the stress reduction layer 21 including more resin components than the stress reduction layer 22 is positioned closer to the mounting surface than the stress reduction layer 22, the stress acting on the mounting surface can be further reduced. Since the stress reduction layer 21 including more resin components than the stress reduction layer 22 overlaps the external electrodes 3 and 4, the multilayer coil component 1B is resistant to deflection of the other electronic device on which the multilayer coil component 1B is mounted.

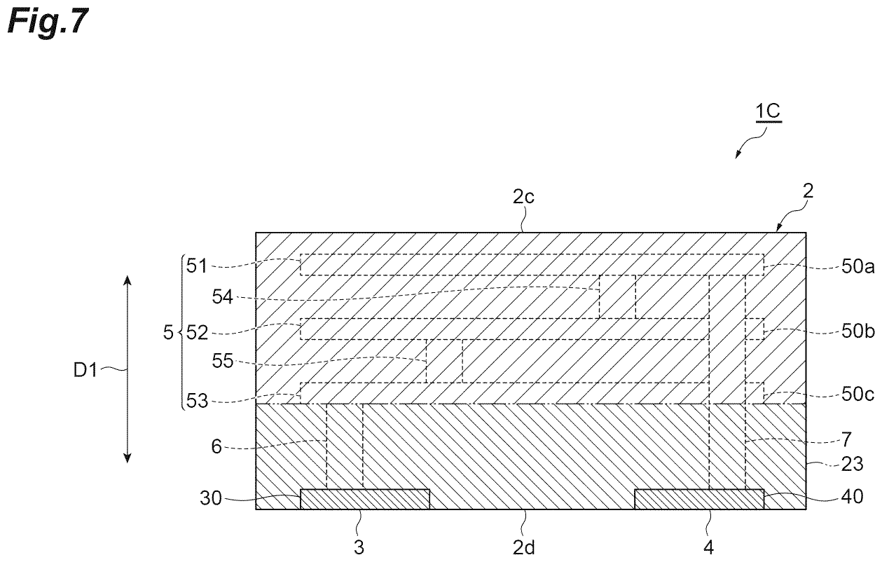

Hereinafter, a multilayer coil component 1C according to a fourth embodiment will be described with reference to FIG. 7. FIG. 7 is a diagram illustrating a configuration of a section of the multilayer coil component according to the fourth embodiment. Hereinafter, differences between the multilayer coil component 1A according to the second embodiment and the multilayer coil component 1C according to the third embodiment will be mainly described.

In the multilayer coil component 1C, the element body 2 includes a stress reduction layer 23 instead of the stress reduction layer 21. The stress reduction layer 23 has a thickness larger than the thicknesses of the external electrodes 3 and 4. The stress reduction layer 23 may have, for example, a thickness that is twice or more the thicknesses of the external electrodes 3 and 4. The stress reduction layer 23 may include a plurality of layers 20h. In one example, the thickness of the stress reduction layer 23 is 1 μm or more and 300 μm or less. The stress reduction layer 23 is along the direction D2 and the direction D3 intersecting the direction D1. End surfaces of the stress reduction layer 23 in the direction D2 may be included in the end surfaces 2a and 2b. End surfaces of the stress reduction layer 23 in the direction D3 may be included in the side surfaces 2e and 2f.

In the multilayer coil component 1C, a portion closer to one end in the direction D1 than the coil 5 of the element body 2 includes the stress reduction layer 23. The stress reduction layer 23 includes the main surface 2d. A thickness of the stress reduction layer 23 is a distance between the coil 5 and the main surface 2d. At least a part of the stress reduction layer 23 is positioned in the same layer as the external electrodes 3 and 4. The stress reduction layer 23 overlaps the external electrodes 3 and 4. The stress reduction layer 23 is disposed to overlap the coil conductor 53.

The stress reduction layer 23 has a thickness larger than the thicknesses of the external electrodes 3 and 4. An external force applied to the multilayer coil component 1C acts on the mounting surface via the stress reduction layer 23. Accordingly, in the multilayer coil component 1C, a change in stress generated in the element body 2 tends not to act on the mounting surface as compared with a configuration in which the stress reduction layer has a thickness smaller than the thicknesses of the external electrodes 3 and 4.

The present disclosure has been described in detail based on the embodiments. However, the present disclosure is not limited to the above embodiments. The present disclosure can be variously modified without departing from the scope of the present disclosure. The first embodiment, the second embodiment, the third embodiment, and the fourth embodiment can be appropriately combined.

As understood from the description of the above-described embodiments and modifications, the present specification includes disclosure of the following aspects.

What is claimed is:

1. A multilayer coil component comprising:
an element body;
a coil disposed in the element body; and
an external electrode electrically connected to the coil and exposed on the element body, wherein
the element body includes a stress reduction layer positioned between the coil and an external electrode.

2. The multilayer coil component according to claim 1, wherein
the stress reduction layer and a portion other than the stress reduction layer in the element body each include a metal component and a resin component, and
a ratio of the resin component to the metal component in the stress reduction layer is larger than a ratio of the resin component to the metal component in the portion other than the stress reduction layer.

3. The multilayer coil component according to claim 1, wherein the stress reduction layer overlaps the external electrode.

4. The multilayer coil component according to claim 1, wherein
the stress reduction layer includes a first stress reduction layer,
the element body further includes a second stress reduction layer different from the first stress reduction layer, and
the second stress reduction layer is positioned between the first stress reduction layer and the coil.

5. The multilayer coil component according to claim 4, wherein
the first stress reduction layer and the second stress reduction layer each include a metal component and a resin component, and
the second stress reduction layer has a ratio of the resin component to the metal component different from a ratio of the resin component to the metal component of the first stress reduction layer.

6. The multilayer coil component according to claim 1, wherein the stress reduction layer has a thickness larger than a thickness of the external electrode.

7. The multilayer coil component according to claim 2, wherein the stress reduction layer has a thickness larger than a thickness of the external electrode.

8. The multilayer coil component according to claim 1, wherein
the stress reduction layer includes a metal component and a resin component, and
a ratio of the resin component to the metal component of the stress reduction layer changes corresponding to a position between the coil and the external electrode in the stress reduction layer.

9. The multilayer coil component according to claim 2, wherein
the stress reduction layer includes a metal component and a resin component, and
a ratio of the resin component to the metal component of the stress reduction layer changes corresponding to a position between the coil and the external electrode in the stress reduction layer.
